(19) United States
(12) Patent Application Publication
(10) Pub. No.: US 2009/0092310 A1
(43) Pub. Date: Apr. 9, 2009

(54) SYSTEM AND METHOD FOR PRECISION FIT ARTIFICIAL FINGERNAILS

(76) Inventors: Craig P. Gifford, Keller, TX (US); Scott L. Nielson, Layton, UT (US)

Correspondence Address: GRANT R CLAYTON;CLAYTON HOWARTH & CANNON, PC, P O BOX 1909, SANDY, UT, 84091-1909, US

(21) Appl. No.: 11/957,456

(22) Filed: Dec. 15, 2007

Related U.S. Application Data
(63) Continuation-in-part of application No. 10/708,065, filed on Feb. 6, 2004, now abandoned.
Application No. 10/708,065 is a continuation-in-part of application No. 10/708,959, filed on Apr. 2, 2004, now Pat. No. 7,082,628.
Application No. 10/708,959 is a continuation-in-part of application No. 10/710,961, filed on Aug. 15, 2004.
Application No. 10/710,961 is a continuation-in-part of application No. 10/710,962, filed on Aug. 15, 2004, now abandoned.
Application No. 10/710,962 is a continuation-in-part of application No. 10/710,971, filed on Aug. 16, 2004, now abandoned.
Application No. 10/710,971 is a continuation-in-part of application No. 11/162,430, filed on Sep. 9, 2005, now abandoned.
Application No. 11/162,430 is a continuation-in-part of application No. 11/162,439, filed on Sep. 9, 2005, now abandoned.
Application No. 11/162,439 is a continuation-in-part of application No. PCT/US2005/003831, filed on Feb. 6, 2005.
Application No. PCT/US2005/003831 is a continuation-in-part of application No. PCT/US2005/003855, filed on Feb. 6, 2005.
Application No. PCT/US2005/003855 is a continuation-in-part of application No. PCT/US2005/004829, filed on Feb. 6, 2005.

(51) Int. Cl. G06K 9/00

(52) U.S. Cl. 382/141

(57) ABSTRACT

A system and method for creating precision fit artificial fingernails is disclosed. Specifically, a system is disclosed that utilizes a scanned and digitized nail surface to form a precision fit three dimensional digitized artificial nail object that can be used to direct a machining device that either creates an artificial fingernail from blank stock, or to machine a custom mold that can be used to make multiple artificial fingernails having the same shape.

### CROSS-REFERENCE TO RELATED APPLICATIONS

This application is a continuation-in-part of the following applications:

U.S. patent application Ser. No. 10/708,065, filed Feb. 6, 2004, entitled Method and Process for Detecting a Nail Surface;

U.S. patent application Ser. No. 10/708,959, filed Aug. 14, 2004, entitled A Method, Process and Computer Program to Automatically Create a Customized Three-Dimensional Nail Object;

U.S. patent application Ser. No. 10/710,961, filed Aug. 15, 2004, entitled A Method, Process and Computer Program to Automatically Create a Customized Three-Dimensional Nail Object by Welding;

U.S. patent application Ser. No. 10/710,962, filed Aug. 15, 2004, entitled A Method, Process and Computer Program to Automatically Create a Customized Three-Dimensional Nail Object by Morphing;

U.S. patent application Ser. No. 10/710,971, filed Aug. 16, 2004, entitled A Method, Process and Computer Program to Automatically Create a Customized Three-Dimensional Nail Object by Library Reference;

U.S. patent application Ser. No. 11/162,430 filed Sep. 9, 2005, entitled Nail Surface Mold Enclosure;

U.S. patent application Ser. No. 11/162,439 filed Sep. 9, 2005, entitled Methods Involving a Molded Impression of a Natural Nail Surface in the Creation of an Artificial Nail;

PCT Application Serial No. US2005/003831 filed Feb. 6, 2005, entitled Creating A Customized Artificial Nail Object;

PCT Application Serial No. US2005/003855 filed Feb. 6, 2005, entitled Distinguishing A Nail Surface From Surrounding Tissue; and

PCT Application Serial No. US2005/004829 filed Feb. 6, 2005, entitled Custom Fit Artificial Nails And Related Systems, Methods, and Software.

All of the above-identified applications are hereby incorporated by this reference herein in their entireties, including but not limited to those portions that specifically appear hereinafter, the incorporation by reference being made with the following exception: In the event that any portion of the above-referenced applications are inconsistent with this application, this application supercedes said portion of said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to artificial fingernails, and toenails and more particularly, but not necessarily entirely, to an artificial nail design method to use in conjunction with the process of designing and manufacturing precision fit artificial nails and related methods and systems.

2. Description of Background Art

Artificial fingernail tips, a desirable fashion (if not also functional) accessory, exist in various forms. One form is a customized artificial fingernail that is made to fit the exact contour and dimensions of a natural fingernail. This offers considerable advantages in comfort, appearance, durability and lasting fit over non-custom fit artificial fingernails commonly available. However, custom fitting an artificial fingernail poses special challenges and problems. Commonly used methods for production of artificial fingernails are very labor intensive, time consuming and require significant skill.

One method for production of artificial fingernails is called “nail sculpturing.” In this method, a pre-made artificial fingernail tip is attached to the tip of a real finger by an adhesive or a supporting sheet. The supporting sheet is attached just under the tip of a real finger. A thermoset material (mainly acrylic type) is then applied little by little onto the natural fingernail from the cuticle of the natural finger and sculpted to cover the whole artificial fingernail tip or a portion of the supporting sheet, such that a uniform extended surface is created. This process is repeated for each finger. Once the thermoset material dries naturally or under ultraviolet lighting, intensive and abrasive filing is applied to create a desired shape for each fingernail. Since this method builds up an artificial fingernail by manually adding material little by little, it gained the name of “nail sculpture.” The last step of this process is to paint the top surface of the artificial fingernails with nail polish to display the desired color or pattern.

Another method to create artificial fingernails is called “nail wrapping.” In this method, fabric pieces are cut off and glued onto a natural fingernail. After a few layers of fabric are glued and dried, coats of filler material are applied to create a continuous uniform surface. After intensive filing to the desired shape, the nail can be polished. This process must be repeated on each finger. Both nail sculpturing and nail wrapping disadvantageously exposes the wearer and nail technicians to fumes, chemical liquids, and filing debris, which can present health and respiratory problems. In addition, the growth of a natural nail will create a gap between its cuticle and applied artificial fingernail since the artificial fingernail, once applied, is bonded onto the natural nail surface. This gap needs to be filled on a regular basis, and this process requires a great deal of time and skill by a nail technician.

A less expensive alternative to the nail sculpturing and nail wrapping methods are the pre-made artificial fingernail tips with, that are pre made with all shape design elements in place, that are capable of being pasted onto the natural fingernail. Some of these pre-made artificial fingernail tips are described as “custom fit.” However, such mass-produced artificial fingernail tips have limited choices in their shapes, lengths, styles and fit. One person's fingernail is different from another person's in its cuticle, width, length, and three-dimensional (3D) shape. Therefore, mass-produced artificial fingernail tips cannot fit exactly to a user's natural fingernail. Usually, such an artificial fingernail tip is forced onto a natural fingernail surface and glued thereon with an adhesive. This technique also poses the problem that such an artificial fingernail tip can be easily removed from the natural fingernail surface using a peeling motion. In addition, this type of artificial fingernail tip is usually recognized as false due to the unfitted shape at the margins.

Another option that solves the problems encountered when using the existing pre-made artificial fingernail tips and the nail sculpturing and nail wrapping methods as described above, is to custom manufacture every artificial fingernail for each wearer. This process may consist of creating a mold from a series of precise impressions of a natural fingernail, with the mold being used to create an artificial fingernail by either injection molding, casting or by hand fabrication. The creation of artificial nails by using this process is still time consuming, costly and requires considerable work by a technician to turn the rough cast into the finished product. It is also impractical to perform this process in a retail nail salon environment.

Because of the disadvantages of the currently known time and or labor intensive methods for making custom fit fingernails, they are relatively expensive and therefore generally must be made of sufficiently durable material that they can be reused. Thus, it would be a significant advance if a method could be devised to allow for the creation of custom fit artificial fingernails through the utilization of processes for designing and fabricating the nails that would allow the nails to be manufactured at a sufficiently low cost that the nails could be disposed of after each use by a wearer.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is an illustration of an artificial nail manufacturing system in accordance with the principles of the present disclosure;

FIG. 2 is an illustration of the digitizing process in accordance with the principles of the present disclosure;

FIG. 3 is an illustration of the process of making a negative mold of the finger in accordance with the principles of the present disclosure;

FIG. 4 is a perspective view of a molded image of a finger;

FIG. 5 is a diagram demonstrating the axis, periphery and digitizing of the nail surface object in accordance with the principles of the present disclosure;

FIG. 6 is a diagram illustrating the library selection method in accordance with the principles of the present disclosure;

FIG. 7 is a diagram illustrating the morphing process in accordance with the principles of the present disclosure;

FIG. 8 is an illustration of the manner in which the nail object morphs into the digitized nail surface to form a new precision fit nail object in accordance with the principles of the present disclosure;

FIG. 9 is diagram showing the new customized nail object fitting over the digitized surface in accordance with the principles of the present disclosure;

FIG. 10 is a diagram showing a nail surface divided into splines in accordance with the principles of the present disclosure;

FIG. 11 is an cross section of a spline object made in accordance with the principles of the present disclosure;

FIG. 12 is a top view of a spline object made in accordance with the principles of the present disclosure;

FIG. 13 is a diagram showing the manner in which the nail tip object is combined with the natural nail object in accordance with the principles of the present disclosure;

FIG. 14 is an illustration of the combining of the digitized top surface with the nail tip in accordance with the principles of the present disclosure;

FIG. 15 is an illustration of the machining process in accordance with the principles of the present disclosure;

FIG. 16 is a depiction of the machining process steps in accordance with the principles of the present disclosure;

FIG. 17 is an illustration of the machining process for machining one half of a mold in accordance with the principles of the present disclosure;

FIG. 18 is an illustration of a the machining process for machining one half of a mold in accordance with the principles of the present disclosure;

FIG. 19 is a perspective view of material used to create two halves of an injection mold;

FIG. 20 is a perspective view of material used to create two halves of an injection mold with cutter path superimposed thereon;

FIG. 21 is a perspective view of a two piece injection mold in accordance with the principles of the present disclosure;

FIG. 22 is a perspective view of an alternative embodiment of an injection mold made in accordance with the principles of the present disclosure;

FIG. 23 is an illustration of the nail inspection process in accordance with the principles of the present disclosure; and

FIG. 24 is an illustration of the nail preparation process in accordance with the principles of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

The present disclosure is directed to an artificial nail design system and method to use in conjunction with the process of designing and manufacturing precision fit artificial nails and related methods and systems. In the description that follows, tasks may be described in a sequence that has been selected to facilitate an understanding of the disclosed embodiments. It should be clear, however, that in practice, many tasks of the present disclosure may be performed in an arbitrary order, and therefore any particular order implied by the description usually represents one of many possibilities.

Importantly, although much of this detailed description uses fingernails to disclose the illustrated embodiments, the present disclosure applies equally to other digits, such as toenails, and therefore the term “nail” will be used when specifically referencing fingernails and/or toenails but when the terms “fingernail” or “fingernails” are used any type of digit is to be included within the scope of such term, as those skilled in the art will understand from the context.

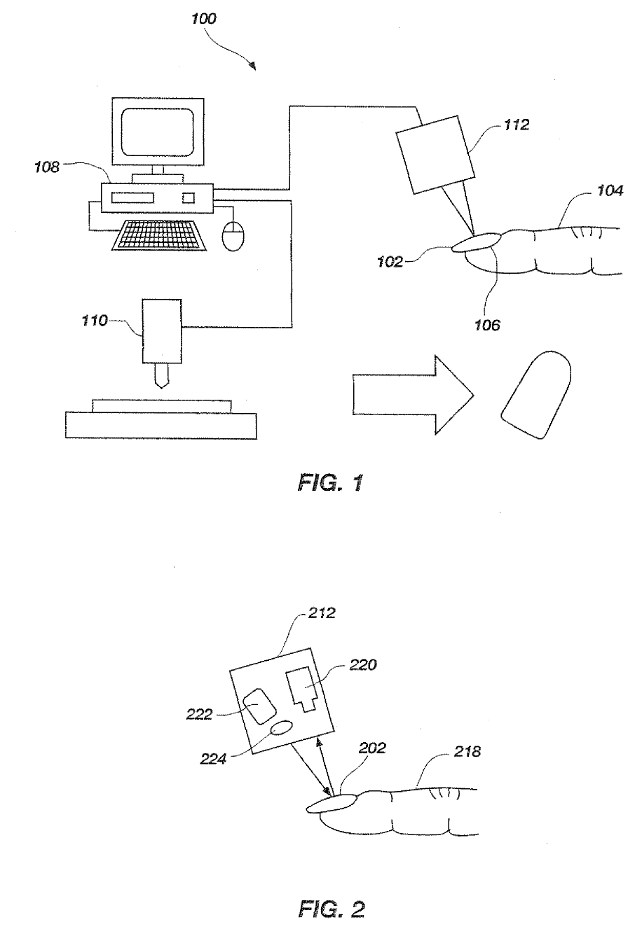

FIG. 1 depicts a precision fit artificial nail system 100 comprising a digitizing device 112, a processor 108 and a machining device 110. The digitizing device 112 captures the topographical, spacial, color, numerical and/or dimensional data of a nail surface 102 in digital form wherein numerical data includes any representation of the nail surface 102 or surrounding tissue 106 in the form of data that may be utilized by a processor executing computer readable instructions and may include any representation of the nail surface 102 by numbers, scientific notation or any other data structure. Color data includes any representation of the nail surface 102 or surrounding tissue by common processor color recognition methods including RGB (Red, Blue, Green) and/or CMYK (Cyan, Magenta, Yellow, Black) and/or gray scale. Spacial data includes any representation of the nail surface 102 or surrounding tissue 106 by amplitude, breadth, width, length or expanse; Further comprising any geometrical coordinate representation similar to an XYZ coordinate system where the data may reflect points and/or vectors and/or vertices to create any type of geometrical lines and/or shape(s). The end result of this procedure is to generate a digitized three-dimensional surface point array of an actual fingernail or toenail.

The digitizing device 112 utilized to obtain the digitized image can be of any type known by those skilled in the relevant art including those capable of taking photographic images, laser imaging, structured light imaging, mechanical measuring, and contact imaging. For example, the digitizing device 112 can be a coordinate measuring device that utilizes a laser or other light source. In the alternative, the digitizing device 112 can be a contact scanner such as a MICROSCRIBE® device. The digitizing device can scan the actual nail, a mold of the nail or a casting of the nail made from a mold of the nail.

As depicted in FIG. 2, another digitizing device 212 comprises a camera 220, a light source 222 and a projection lens 224. The camera 220 is either an analog or digital video camera with an imaging capability as an area type or line type imager. The light source 222 is a white light for projecting a grid (not shown) onto the nail surface 202. While the grid is projected onto the nail surface 202, the camera 220 is used to obtain an image(s) of the grid. The images(s) are then transferred to the measuring and design system for calculating the three-dimensional topography of the nail surface 202.

In an alternative embodiment, the light source 222 (FIG. 2) comprises a laser used to measure the three-dimensional topography of the nail surface 202. In this alternative embodiment, the laser light source 222 scans a strip across the nail surface 202 and the camera 220 records the image. A laser triangulation algorithm is then used to determine the three-dimensional topography of the nail surface 202. The laser digitizing can be achieved by translating the light source 222 or by shifting the nail surface 202, as can be determined by those having skill in the art. Other ways of scanning the nail surface 202 with a laser light source 222 can alternately be used including rotation of a mirror (not shown) for rotatably scanning the laser across the nail surface 202 without movement of the light source 222.

In either the white light embodiment of the light source 222 or the laser embodiment of the light source 222 the imaging and scanning process are advantageously brief, allowing a user of the artificial nail production system to quickly scan and measure the three-dimensional topography of a plurality of nails.

When using the white light embodiment of the light source 222, the grid which is projected onto the nail surface 202 will deform in accordance with the topography of the nail surface 202. The deformations of the grid of the nail surface 202 are recorded by the camera 220 as a two-dimensional grid image. Different algorithms can be used to decode this two-dimensional deformed grid image into a three-dimensional topography of the nail surface 202.

Algorithms for decoding the two-dimensional deformed grid image include: phase shifting; Fourier transforming; spatial coding; and Sinusoidal fitting. These algorithms will provide a phase map at the end of the calculation which is converted into three-dimensional coordinates for each pixel of the grid image. These calculations are performed by the measuring and design system. Both the laser scanning and white light grid methods will generate a set of points with known x, y, and z axis coordinates to represent the three-dimensional topography of the nail surface 202. The x, y, and z coordinates also define the boundary between the finger 218 and the nail surface 202. By using these non-contact methods, the total number of data points measured for a nail can be easily over 200,000 points. The x, y, and z axis coordinates are saved in the system's storage capacity in any number of known digital formats which can be selected by those skilled in the art.

Still referring to FIG. 2, the boundary of the nail surface 202 can be determined by one of the following techniques: (1) Drawing an outline of the nail surface 202 on the screen of a monitor by using a pointing device; or, (2) Automatically determining the boundary of the nail surface 202 by a boundary extraction algorithm. Both techniques are well known to those skilled in the relevant art.

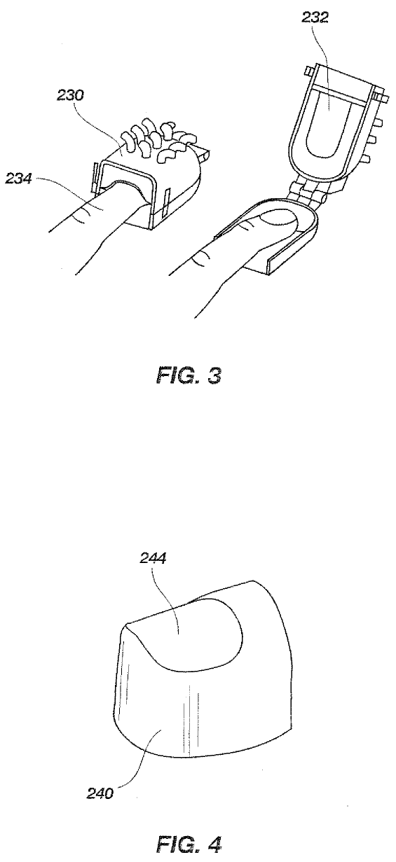

FIG. 3 depicts an embodiment of the present disclosure wherein a mold 230 is used to make an impression 232 of the finger 234. The material used to make the impression 232 of the finger 234 can be comprised of any material that is dimensionally stable, such as polyvinyl siloxane, alginate, or wax, which can be selected by those skilled in the pertinent art. The impression 232, also referred to herein as the negative image, created by the mold 230 can be scanned via any of the methods outlined above, either alone or in combination.

FIG. 4 depicts an embodiment wherein the impression 232 in FIG. 3 is used to make a molded image 240 of the finger including the nail 244. This can be accomplished by injecting the mold with any material which is dimensionally stable, such as polyvinyl siloxane, alginate, wax or other suitable casting material known in the art. The nail surface 244 contained on this molded image 240 can then be scanned via any of the methods discussed above.

It will be appreciated that the various embodiments set forth above in connection with FIGS. 2-5 are merely one example of a means for creating a digitized natural nail image, and it should be appreciated that any structure, apparatus or system for creating a digitized natural nail image which performs functions the same as, or equivalent to, those disclosed herein are intended to fall within the scope of a means for means for creating a digitized natural nail image, including those structures, apparatus or systems for creating a digitized natural nail image which are presently known, or which may become available in the future. Anything which functions the same as, or equivalently to, a means for means for creating a digitized natural nail image falls within the scope of this element.

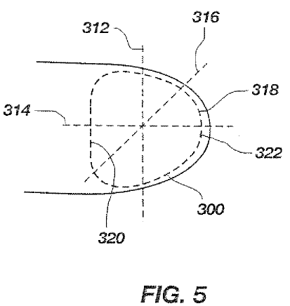

Referring now to FIG. 5 which depicts a digitized natural nail surface 300, generated by the one of the digitizing devices disclosed herein. The digitized natural nail surface 300 is represented by data establishing the orientation of X, Y and Z axes respectively of the digitized natural nail surface. Here the X-axis 312 defines the width of the digitized natural nail surface 300 along a horizontal plane; The Y-axis 314 defines the length of the digitized natural nail surface 300 along a horizontal plane and can be determined initially by measuring from the cuticle 320 to the tip 322 of the digitized natural nail surface 300; and, The Z-axis 316 which represents the orientation of the nail surface 300 along a vertical plane.

Additionally, the periphery points 318 of the digitized natural nail surface 300 are also determined in a step to insure that the digitized artificial nail object will fit within the digitized natural nail surface 300 dimensions.

The step of creating the digitized natural nail surface area includes creating a relationship between the X-axis 312, Y-axis 314 and Z-axis 316 and generating a plurality of data points that define the natural nail surface along the X-axis 312, the Y-axis 314 and Z-axis 316 with each data point having a specific orientation along the X-axis, Y-axis and Z-axis. Arcs of the digitized natural nail surface 300 are then reflected in the data points that result from the relationships between the X-axis 312, Y-axis 314 and Z-axis 316 at the relevant points on the natural nail surface. These arcs include the curvature of the nail along the X-axis, and the curvature of the natural nail surface along the Y-axis. These arcs as well as the other relevant parameters of the digitized natural nail surface image can be manipulated during the digitized artificial nail object creation process.

Returning to FIG. 1, the system 100 also comprises a processor 108 capable of executing computer readable instructions. As used herein, a processor comprises a circuit or any combination of circuits capable of processing digital code programmed by a programmer. For example, the processor can comprise a computer or a digital device adhering to the personal computer standard or the MACINTOSH® standard. Digital code as used herein comprises machine readable instructions. After the data representing the nail surface 202 is generated, the digitizing device makes the data available to the processor 108.

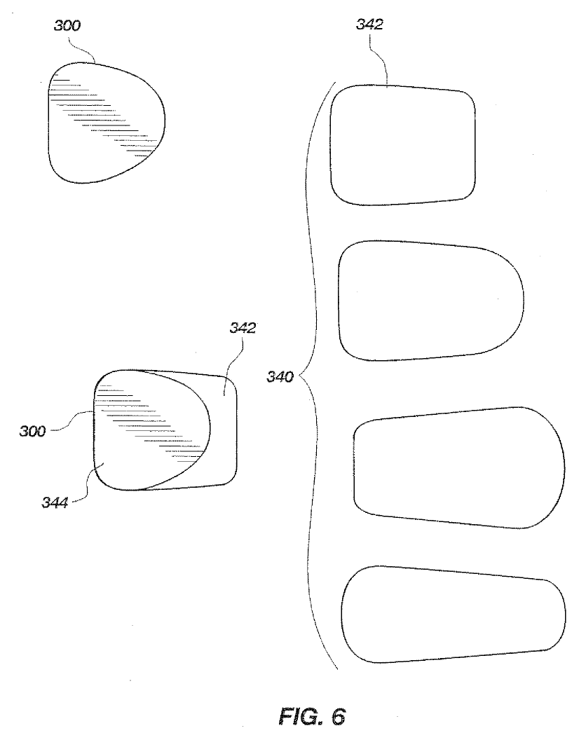

The embodiment illustrated in FIG. 6 represents one approach in which the processor executes machine readable instructions by comparing the data representing the digitized natural nail surface with a library 340 of digitized artificial nail objects and selecting the digitized artificial nail object 342 from among the library 340 of digitized artificial nail objects that substantially matches the digitized natural nail surface 300. This embodiment of the present disclosure may be referred to herein as a “library method.”

The library of digitized artificial nail objects 340 also can be categorized according to types of digitized three-dimensional designs, with each category of design containing variants, with each variant being differently sized and shaped in the area 344 where the digitized artificial nail object 342 intersects the digitized natural nail surface 300. In this embodiment of the present disclosure, the processor executing computer readable code selects the variant of the digitized artificial nail object 342 within a specified category that most resembles the digitized natural nail surface 300.

FIG. 6 shows the library selected digitized artificial nail object 342 aligned with the digitized natural nail surface 300. The library selected digitized artificial nail object 342 represents the final digitized artificial nail object that can then be utilized to create a precision fit artificial nail.

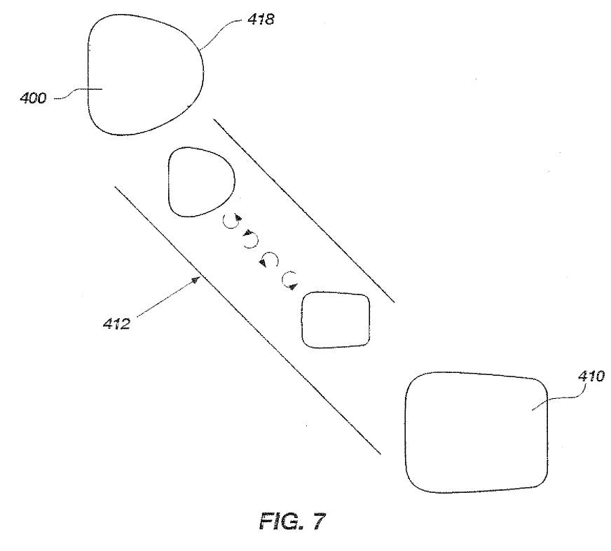

The exemplary embodiment represented in FIG. 7 illustrates a method to alter data representing a digitized artificial nail object 410 to conform to and fit the digitized natural nail surface 400 that may be referred to herein as “morphing.” In this method, the processor (see FIG. 1) accesses data representing the digitized natural nail surface 400 as well as data representing a digitized artificial nail object 410. The data representing the digitized artificial nail object 410 can be either supplied by the user, preselected by the user from among two or more existing digitized artificial nail objects, or can be selected by the processor from among one or more existing digitized artificial nail objects 410. In addition, the digitized artificial nail object 410 can be manually designed and supplied to the processor by the user, for example by using an available software program such as 3-D STUDIO MAX™, RHINO™ SOLIDWORKS® or other comparable programs or hardware capable of designing an digitized artificial nail object 410. In addition, the digitized artificial nail object 410 can be supplied by scanning an actual artificial nail to produce a digitized image which is then supplied to processor (108 in FIG. 1).

The data representing the selected digitized artificial nail object 410 is then manipulated by the processor executing computer readable code to create a digitized artificial nail object 410 that resembles the digitized natural nail surface 400.

Still referring to FIG. 7, the morphing is illustratively accomplished by mathematically altering the data representing the selected digitized artificial nail object 410 to the data representing the digitized artificial nail object 410 more similar to the data representing the digitized natural nail surface 400. This morphing process can be accomplished through several iterations, represented at 412, with the digitized artificial nail object 410 made to appear more like the digitized natural nail surface 400 during each morphing iteration 412. It is to be appreciated that the appearance of the nails illustrated in FIG. 7 is merely representative of the myriad shapes which may be accomplished in accordance with the present disclosure.

The periphery points 418 of the digitized natural nail 400 surface may remain constant when morphing from the digitized artificial nail object 410 to the digitized natural nail surface 400 so as to insure that the new digitized artificial nail object 410 created by morphing will combine successfully with the digitized natural nail surface 400. The computer readable instructions executed by the processor (108 in FIG. 1) may perform self analysis via mathematical algorithms, formulas or coded processes in manipulating the data in order to ensure that the finished digitized artificial nail object 410 conforms to certain predetermined parameters in terms of width, length, thickness, etc.

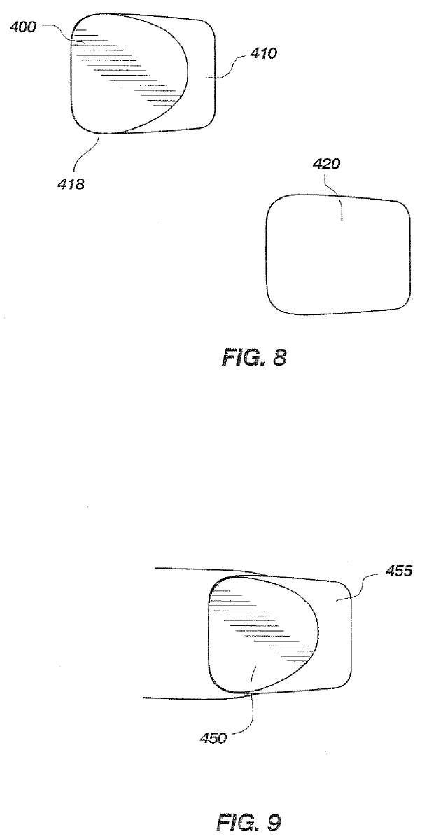

FIG. 8 shows the morphed digitized artificial nail object 410 combined with the digitized natural nail surface 400 as one precision fit nail object 420. In order to successfully create the desired precision fit digitized artificial nail object 420, the digitized natural nail surface 400 has been aligned with the bottom of the digitized artificial nail object 410. In one illustrative approach, at the intersection of the digitized natural nail surface 400 with the digitized artificial nail object 410, every point of intersection of the digitized artificial nail object 410 has been dropped and in their place is substituted the intersecting points of the digitized natural nail surface 400. Advantageously, this approach creates a precision fit along the bottom of the digitized artificial nail object 410, by mathematically changing the digitized artificial nail object 410 to appear more like the digitized natural nail surface 400.

By utilizing the periphery points 418 along the edge of the digitized natural nail surface 400 as reference points, any voids or overhangs will be substantially remedied. In the event of an overhang of points in the digitized artificial nail object 410, those points that exist beyond the digitized natural nail surface 400 will be dropped so that the selected digitized artificial nail object 410 will align along the periphery 418 of the digitized natural nail surface 400. In the event of a void, meaning that the selected digitized artificial nail object 410 is missing a point that should exist to match with the periphery 418 of the digitized natural nail surface 400, those points will be created in the selected digitized artificial nail object 410 so that the digitized artificial nail object 410 will align along the periphery 418.

FIG. 9 depicts an illustrative embodiment involving creating a digitized artificial nail object via a method that may be referred to herein as creating “on the fly.” In this embodiment, the processor accesses the data representing the digitized natural nail surface 450. The processor then executes computer readable instructions to generate additional data sufficient to represent a digitized artificial nail object 455 that substantially conforms to a set of predetermined parameters and merges that data with the data representing the digitized natural nail surface 450. The predetermined parameters are selected by the user from one or more of the following: length, width, arcs, thickness, three dimensional style and/or tip shape. The computer readable instructions executed by the processor (108 in FIG. 1) employ certain mathematical algorithms, formulas or coded processes to create a final three dimensional digitized artificial nail object whose bottom surface conforms to the contour and shape of the digitized natural nail surface and whose overall shape and design conforms to the preselected parameters. This may be referred to as a calculation module. The computer readable instructions executed by the processor may perform self analysis via mathematical algorithms, formulas or coded processes in manipulating the data in order to ensure that the finished digitized artificial nail object conforms to certain predetermined parameters in terms of width, length, thickness, etc.

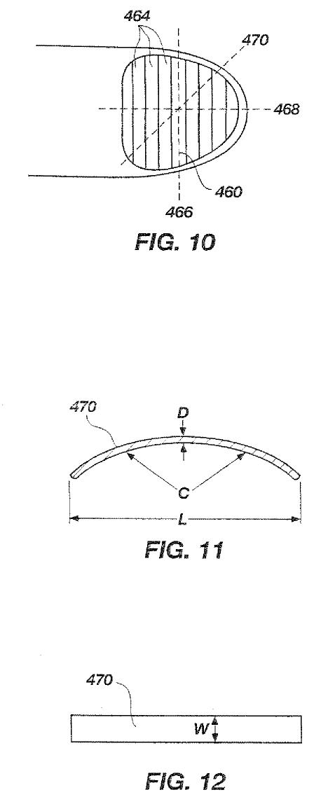

FIG. 10 depicts an illustrative embodiment that involves creating a three dimensional nail object using splines. In this embodiment, the digitized nail surface 460 is divided into a series of splines 464. As used herein, the term “spline means a digitized representation of a segment of the digitized natural nail surface 460 having a length, width, and curvature. Each digitized natural nail surface 460 may be represented by a plurality of splines 464 that may be the same or may differ from each other in terms of length, width and/or curvature. Each spline 464 is arranged on the basis of its orientation with respect to the X-axis 466, the Y-axis 468 and the Z-axis 470 of the digitized nail surface 460 and the data that represent each spline 464 are determined.

With respect to each spline 464, the processor (108 in FIG. 1) can execute a set of computer readable instructions to select appropriate spline objects 470 as depicted in FIG. 11. A spline object 470 comprises data defining an object having length L, a curvature C and a depth D. The spline object 470 also has a width D as depicted in FIG. 12. The processor may execute computer readable code to select the particular spline object 470 that best conforms to the data that defines a particular spline 464. The closest conforming spline object 470 can then be imported into the design of the digitized artificial nail object, or the spline object 470 can be further manipulated either manually or by the processor to conform more exactly to the spline 464 either before or after being imported into the design of the digitized nail image. In the alternative, the processor may execute computer readable code to design individual spline objects 470 on the fly to comport with a set a preselected parameters.

In another exemplary embodiment, the general size, shape and contours of the digitized artificial nail object can be determined by the user by manually selecting a group of spline objects 470 that are so selected and placed to define the overall general size, shape and contours of the desired digitized artificial nail object. The processor may then execute computer readable instructions to generate additional data required to generate appropriate spline objects between the selected splines in order to create a three dimensional digitized artificial nail object.

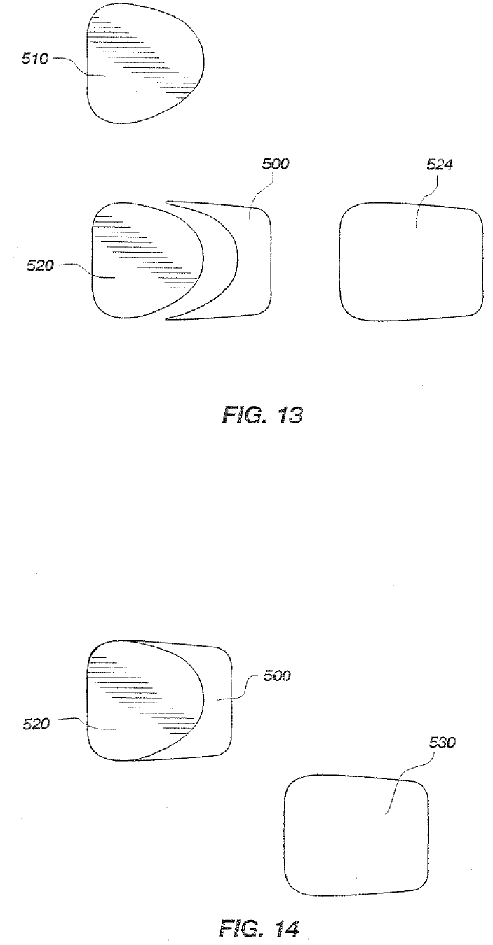

FIG. 13 depicts an illustrative embodiment wherein a digitized artificial nail tip object 500 is combined with the digitized natural nail surface 510 in a method that may be referred to herein as the “artificial nail tip method.“The digitized artificial nail tip object 500 may be obtained either from a preselected library of digitized artificial nail tip objects, by morphing a selected digitized artificial nail tip object 500 to conform to the general contours of the digitized natural nail surface 510, generating a digitized artificial nail tip object 500 according to a set of predetermined parameters such as length, width and/or shape, or generating a digitized artificial nail tip by using splines or by any combination of these processes or by and other process or combination of processes known in the art.

Once the digitized artificial nail tip object 500 is selected, the digitized natural nail surface 510 is duplicated to create second digitized natural nail surface 520. The duplicated natural nail surface 520 is raised on its Z-axis a determined distance so as to create a preferred depth to the precision fit artificial nail object. Often, the duplicated natural nail surface 520 will require smoothing. The smoothing process is achieved by comparing each point along the duplicated natural nail surface 520 to surrounding points and if a point falls outside a predetermined preferred range, that point is manipulated accordingly to the smoothing function and brought into the scope of its surrounding points in three-dimensional space. Once the duplicated natural nail surface 520 has been smoothed, the duplicated natural nail surface 520 is attached to the selected tip object 500.

FIG. 14 shows the combination of the selected tip object 500 with the duplicated digitized natural nail surface 520 to create a precision fit artificial nail object 530. This combination occurs by aligning the bottom of the selected tip object 500 with the bottom of the edge of the digitized natural nail surface 510. Once all three objects (duplicated nail surface 520 (FIG. 13), selected tip object 500 (FIGS. 13 & 14) and digitized natural nail surface 510 FIGS. 13 & 14)) are properly aligned, smoothed and blended to the extent required, they are combined to form a new precision fit three dimensional nail object 530 (FIG. 14).

The digitized artificial nail object can be made by any of the above alternatives alone or by any combination of two or more of any of the above alternative embodiments or by one or more of the above alternatives in combination with another process selected by those skilled in the art.

It will be appreciated that the various embodiments set forth above in connection with FIGS. 6-14 are merely one example of a means for creating a digitized artificial nail object, and it should be appreciated that any structure, apparatus or system for creating a digitized nail object which performs functions the same as, or equivalent to, those disclosed herein are intended to fall within the scope of a means for means for creating a digitized artificial nail object, including those structures, apparatus or systems for creating a digitized artificial nail object which are presently known, or which may become available in the future. Anything which functions the same as, or equivalently to, a means for means for creating a digitized artificial nail object falls within the scope of this element.

Returning to FIG. 1, the system 100 may also comprise a machining device 110 for manufacturing an artificial nail based on the digitized artificial nail object generated by the processor 108 and outputted in a form suitable for directing the operations of a machining device. The system may utilize a computer assisted machine (CAM) program or other program that generates machine usable codes capable of being used by machining devices 110. The machining device 110 may comprise any device capable of executing computer readable instructions to machine a physical object according to certain determined design parameters. For example, the machining device 110 may be used to mill a precision fit artificial nail, to fashion a mold for a precision fit artificial nail.

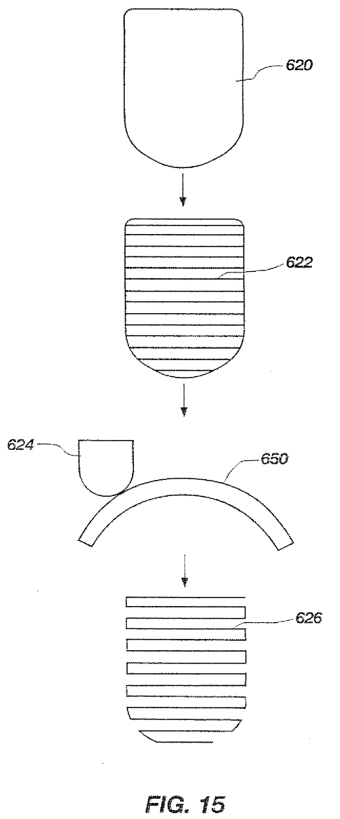

FIG. 15 is a depiction of an illustrative machining process for direct milling of precision fit artificial nail production. The machining process of the artificial nail production system starts with providing a material 620 for machining. A series of cutting parameters 622 are generated to conform to the contours of the nail object. For example, these cutting parameters can comprise a set of lines along either the intended nail width or nail length direction at a predetermined spacing. Based on the profile of the cross-sectional lines 622, the best position of the machining tool 624 is calculated at certain step sizes to create a three-dimensional cutter path 626. Finally, the three-dimensional cutter path 626 data is saved as a series of codes in a form readable by a machining device 110 (FIG. 1) such as a CNC machine (computer numerical control machine) or stereo lithography (3-D layering) device. If a CNC machine is used, the CNC machine can utilize as its cutting mechanism one or more of the following either alone or in combination: cutting blades, laser, electrodes, plasma, water, air, or any combination of these or of other machining techniques or devices known in the art from any number of manufacturers known to those skilled in the art. The material 620 for making the artificial nail can advantageously be any desirable and suitable plastic, composite, ceramic, metal or other material.

The machining device 110 (FIG. 1) will have at least three motor-driven translation axes perpendicular to each other. The machining tool 624 represented in FIG. 15 is capable of being controllably positioned along at least two perpendicular directions. The material 620 provided may have a length, width and height sufficient to accommodate at least one finished artificial nail or multiple finished artificial nails.

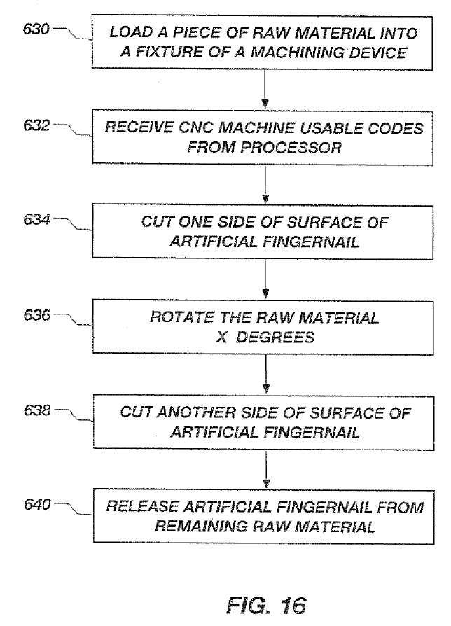

Referring now to FIG. 16, in a first step 630 of the machining process, the material 620 (FIG. 15) is loaded into the machining device 110 (FIG. 1). In step 632, machine usable codes previously created are received by the machining device 110. Next, in step 634, one side of the surface of the material 620 for the artificial nail is cut. This is followed in step 636 wherein rotating the material 620 is rotated, for cutting, in step 638, additional surfaces of the artificial nail until all surfaces are cut and/or shaped. As an alternative to rotating the material (step 636), the material can be held stationary and the cutting tool can rotated around the material until all surfaces are cut and/or shaped. The artificial nail is next released from any remaining material in step 640. The end result is a precision fit or custom fit three dimensional nail for fingernail. A portion of the artificial nail or fingernail may at least semi-rigidly retain a shape that substantially matches a top surface of the natural fingernail. It is beneficial that the material 620 (FIG. 15) can be of sufficient size and shape to mill multiple nails. In order to accomplish this desirable result, it is within the scope of the present disclosure to use more than one cutting head on the machining device (110 in FIG. 1).

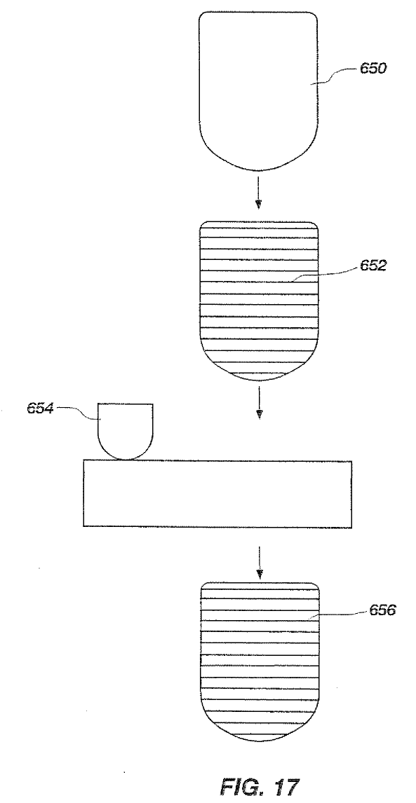

FIGS. 17 & 18 depict an alternative machining process wherein the digitized artificial nail object is utilized within a CAM (computer aided manufacturing) or similar program to generate computer readable code to direct the milling of an injection mold that may be used for injection molding of a precision fit artificial nail. As depicted best in FIG. 17, the machining process of the injection mold starts with providing a material 650 for machining. This material can be aluminum, steel, copper, brass, bronze, lead, plastic, composite, ceramic, or other suitable material. A series of cross-sectional lines 652 are generated along either the intended nail width or nail length direction at a predetermined spacing. Based on the profile of the cross-sectional lines 652, the best position of the machining tool 654 is calculated at certain step sizes to create a three-dimensional cutter path 656 conforming to the upper surface of the artificial nail object.

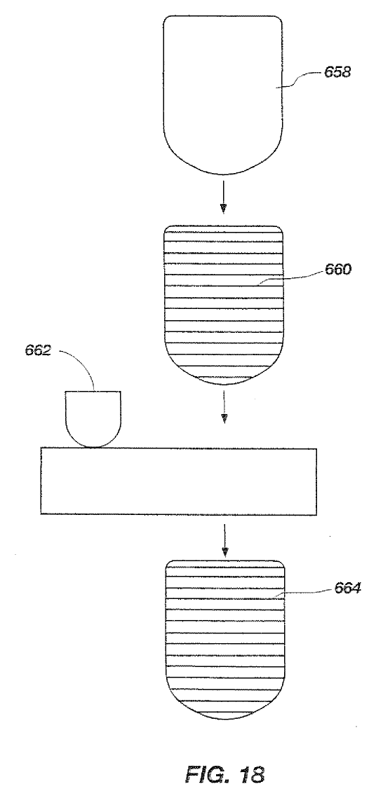

As depicted best in FIG. 18, a second piece of material 658 for machining is provided. This material can be aluminum, steel, copper, brass, bronze, lead, plastic, composite, ceramic, or other suitable material. A series of cross-sectional lines 660 are generated along either the intended nail width or nail length direction at a predetermined spacing. Based on the profile of the cross-sectional lines 660, the best position of the machining tool 662 is calculated at certain step sizes to create a three-dimensional cutter path 664 conforming to the lower surface of the digitized artificial nail object.

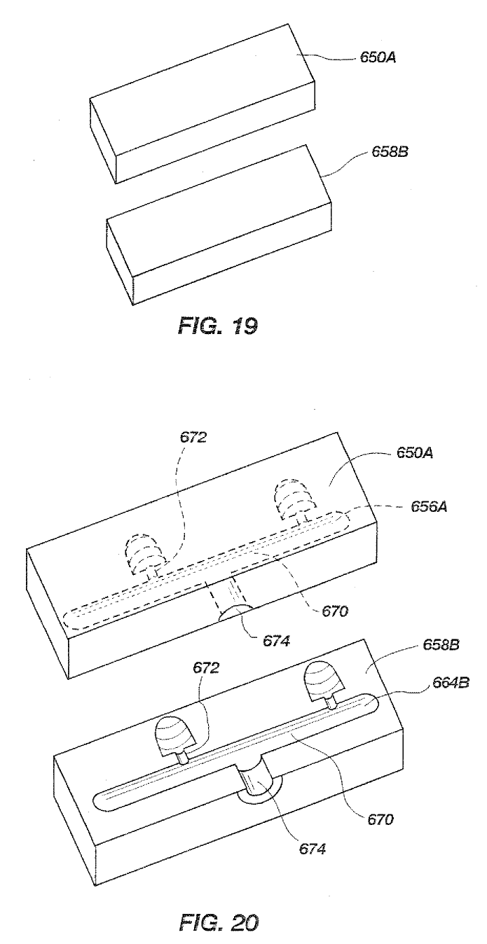

Referring now to FIG. 19, there are shown two pieces of material to be milled into two halve of an injection mold. Material 650A corresponds to the material that will be milled to conform to the upper surface of the artificial nail object. Material 650B corresponds to the material that will be milled into to conform to the lower surface of the artificial nail object.

FIG. 20 represents the material that will be milled to conform to the upper surface of the artificial nail object 650A with the cutter path 656A that conforms to the upper surface of artificial nail surface superimposed thereon. The cutter paths, 650A and 656B, respectively, will direct the machining device (110 in FIG. 1) to mill the material 650A and 658B respectively to create therein an image conforming in shape to the upper and lower surfaces of the artificial nail object. FIG. 20 also depicts the cutter paths that will direct the machining device (110 in FIG. 1) to mill the runners 670, gates 672 and sprue 674.

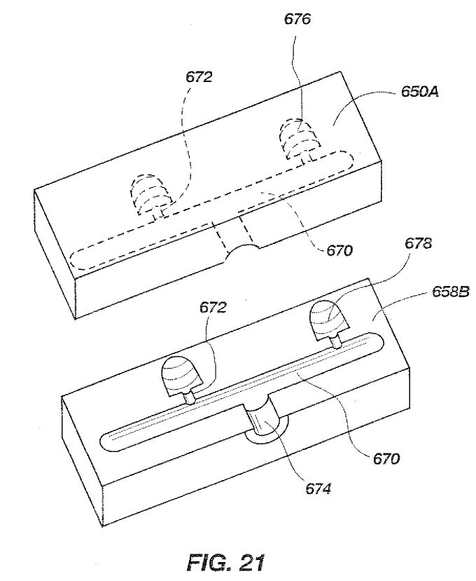

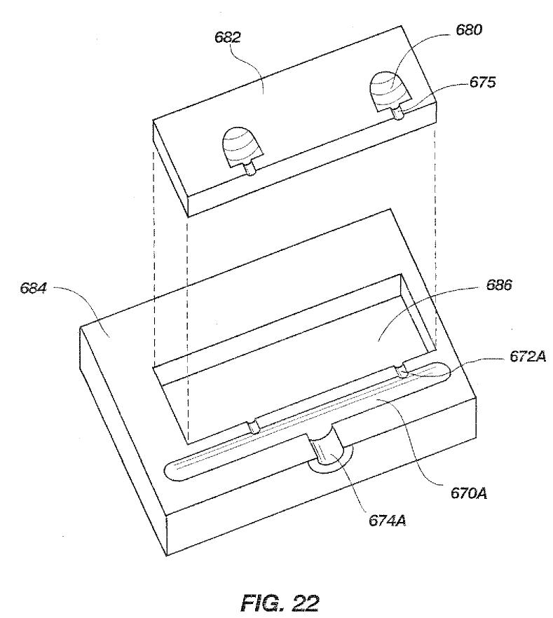

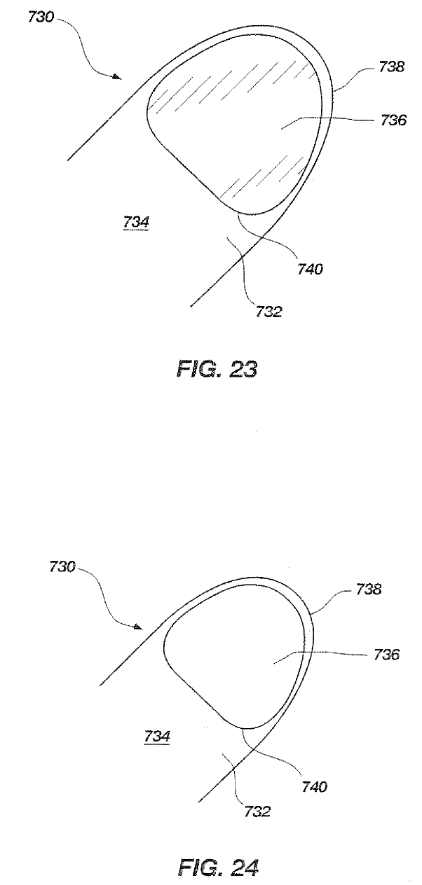

FIG. 21 is a depiction in phantom of the milled two piece mold comprising and upper half 650A in which has been milled a cavity 676 conforming to the upper surface of the artificial nail object along with runners 670, gates 672 and sprue 674. Also depicted is the lower half 658A of the mold into which has been milled a cavity 678 conforming to the lower surface of the artificial nail object along with runners 670, gates 672 and sprue 674.

The controlling program can also direct the machining device (110 in FIG. 1) to mill a mold half 682 comprising a cavity corresponding to a surface of the artificial nail object 680 along with gates 675. The mold half 682 can then be inserted into a precut main mold 684 that contains gates 672A runners 670A and sprue 674A along with a cavity 686 sized and shaped to receive the mold half 682. The mold half 682 may then be inserted into the precut main mold 684 in such a manner that the gates 675 of the mold half 682 align with the gates 672A of the precut main mold 684.

These molds 676 and 676A can then be used for any type of molding process including injection molding, compression molding, casting, rotational molding, blow molding and so forth, which can be selected by those skilled in the art using the disclosure provided herein. It is also within the scope of the present disclosure that the machining device 110 (FIG. 1) can also machine wax or other meltable substance that can be used to form a template for a mold for a metal as in the lost wax casting method.

In yet another embodiment of the present disclosure, the three dimensional digitized artificial nail object can be used to generate machine readable codes for driving a stereo lithography, 3-D prototyping machine as is known in the industry and those skilled in the art will appreciate the advantages which will accrue by the use of the same.

It will be appreciated that the various embodiments set forth above in connection with FIGS. 15-20 are merely one example of a means for machining either an artificial nail or for machining an injection mold for injection molding an artificial nail, and it should be appreciated that any structure, apparatus or system for machining either an artificial nail or for machining an injection mold for injection molding an artificial which performs functions the same as, or equivalent to, those disclosed herein are intended to fall within the scope of a means for machining either an artificial nail or for machining an injection mold for injection molding an artificial nail, including those structures, apparatus or systems for machining either an artificial nail or for machining an injection mold for injection molding an artificial nail which are presently known, or which may become available in the future. Anything which functions the same as, or equivalently to, machining either an artificial nail or for machining an injection mold for injection molding an artificial nail falls within the scope of this element.

In some instances, the digitizing device (112 in FIG. 1) may have difficulty in obtaining an accurate image of the natural nail surface. This can be because, for example, the digitizing device (112 in FIG. 1) has difficulty distinguishing between the natural nail surface and the surrounding tissue. Thus, it may be helpful if the natural nail surface is inspected and prepared prior to the digitizing process in order to assist the digitizing device (112 in FIG. 1) accurately capturing the natural nail surface.

Accordingly, FIG. 23 is an illustration of the present disclosure with regard to the step of preparation of the object to be digitized 730. In this example, the finger 732 is illustrated and the overall step involves visually inspecting the object 730 including the surrounding tissue 734 and the natural nail surface 736. Visual inspection involves the method and process of ascertaining any surrounding tissue 734 coverages upon the nail surface 736 and determining the best way to remove any surrounding tissue 734, if necessary to expose the appropriate nail surface 736 required for successful digitizing. During the visual inspection it is determined if a manicure/pedicure or other finish work needs to be performed in order to effectively prepare the nail surface for digitizing. When done correctly, this step will have removed all surrounding tissue 734 in relationship to the nail surface 736 exposing the nail and its periphery from tip 738 to cuticle 740.

It is anticipated that a digital inspection may occur to compare the object 730 against other similar objects (not shown) to determine if the object 730 needs additional finish work before proceeding to the next stage of the disclosure. It is anticipated that digital inspection may take the forms of photographic images, laser imaging, structured light imaging and mechanical measurements; Other technologies may be utilized to digitally capture the object and do comparison and analysis work. It is further likely that no additional finish work need be performed to prepare the object for digitizing, as a result of the preparation step, in which case the preparation step would be concluded.

As shown in FIG. 21, the preparation step has been successfully concluded and the next step is the application of the coating composition 700. The coating composition 700 may be comprised of any type of opaque, non-transparent, impenetrable, obscured, glossy, luminescence or semi-gloss substance, such as a paint, veneer, covering, layer, dye or other coating. Additional forms of coverings may include stencils or cutouts, which are designed to fit the nail surface 702 or the surrounding tissue 704 and distinguish the nail surface 702 from the surrounding tissue 704.

In one illustrative embodiment, the present disclosure may include some type of non-toxic opaque and/or matte painting composition which can be applied and then removed after digitizing to the nail surface 702. The application of the coating composition 700 may be done uniformly and evenly.

The inspection and application of the coating composition steps make the digitizing of the object particularly efficient and accurate, by assisting the digitizing device 10 in distinguishing between the nail surface object and the surrounding material. By successfully completing the previous steps, virtually any digitizer would be capable of separating the nail surface object information into any processor recognizable format. A principle object of this embodiment of the present disclosure is to create an efficient method and process to separate object information, specifically a nail surface 702 from its surrounding tissue 704. The application of this disclosure is extensive and plentiful, as with this disclosure those skilled in the art will readily digitize an object and quickly and efficiently distinguish multiple objects within the same digital information gathered. Because of the advantages inherent in the present disclosure it is anticipated that many variants of this disclosure are possible, which are intended to be included within the scope of the illustrated embodiments and descriptions provided herein.

A potential objective of the present disclosure may include creating a simplified method, process and program to automatically create a precision fit artificial nail. Because of the advantages inherent in this disclosure it is anticipated that many variants of this disclosure are possible, which should be included within the preferred embodiments and descriptions of this disclosure.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for creating an artificial fingernail comprising:
a processor for processing data representing a natural nail surface; and,
a machining device capable of machining an artificial fingernail, wherein the processor outputs data to the machining device in a form capable of being executed by the machining device.

2. The system of claim 1 wherein the output data from he processor defines a digitized artificial nail object.

3. The system of claim 1 further comprising a digitizing device that generates and makes available to the processor data representing a digitized natural nail surface.

4. The system of claim 3 wherein a natural nail surface is prepared in a manner to assist the digitizing device in accurately capturing the natural nail surface.

5. The system of claim 4 wherein the preparation of the natural nail surface includes applying a coating composition to the natural nail surface.

6. The system of claim 3 wherein the digitizing device scans a natural nail surface.

7. The system of claim 3 wherein the digitizing device scans a negative mold of a natural nail surface.

8. The system of claim 3 wherein the digitizing device scans a molded image of a natural nail surface.

9. The system of claim 3 wherein the digitizing device comprises a contact type digitizing device.

10. The system of claim 3 wherein the digitizing device comprises a non-contact type digitizing device.

11. The system of claim 10 wherein the non-contact type digitizing device comprises a laser.

12. The system of claim 10 wherein the non-contact type digitizing device comprises a structured light scanner.

13. The system of claim 1 wherein the machining device is utilized to mill artificial nails from blank stock.

14. The system of claim 13 wherein the artificial nails comprise artificial fingernails

15. The system of claim 1 wherein the machining device is utilized to create a custom injection mold.

16. The system of claim 15 wherein the custom injection mold is sized and shaped to fit within a master mold that contains runners and sprue.

17. The system of claim 1 wherein the machining device comprises a CNC machine.

18. The system of claim 1 wherein the machining device comprises a stereo lithography (3-D layering) device.

19. The system of claim 1 wherein the processor executes computer readable instructions selected from at least one of the following:
a. comparing data representing the digitized natural nail surface with a library of digitized artificial nail objects and selecting a digitized artificial nail object from the library that substantially matches the contours of the digitized natural nail surface;
b. manipulating data representing an artificial nail object via a morphing process to make the data representing the artificial nail object similar to the data representing the digitized natural nail surface;
c. manipulating data representing the digitized natural nail surface and generating additional data sufficient to generate a digitized artificial nail object that substantially conforms to a set of predetermined parameters;
d. comparing data representing the spline with a library of spline objects and selecting a spline object that substantially matches the data representing the spline; and
e. merging data representing the digitized natural nail surface with a preselected artificial nail tip object to create an artificial nail object.

20. A method for selecting a digitized artificial nail object comprising:
a. receipt by a processor of data representing a digitized natural nail surface; and
b. execution by the processor of computer readable instructions which include the following:
i. comparing data representing the digitized natural nail surface with a library of digitized artificial nail objects; and
ii. selecting a digitized artificial nail object from the library that substantially matches the contours of the digitized natural nail surface.

21. The method of claim 20 wherein the data is positioned on an X-axis, Y-axis and Z-axis.

22. The method of claim 21 wherein the method further includes measuring key reference points of a natural nail surface along the natural nail surface's X-axis, Y-axis, and Z-axis to obtain the data representing the digitized natural nail surface, where the X-axis represents the natural nail surface's width along a horizontal plane, the Y-axis represents the natural nail surface's length along a horizontal plane and the Z-axis represents the natural nail surface's height along a vertical plane.

23. The method of claim 23 wherein the step of measuring key reference points includes determining an arc of the natural nail surface along the X-axis and determining the arc of the natural nail surface along the Y-axis.

24. A method for creating a digitized artificial nail object comprising:
a. receipt by a processor data representing a digitized natural nail surface; and
b. execution by the processor of computer readable instructions that include manipulating data representing an artificial nail object via a morphing process to make the data representing the artificial nail object similar to the data representing the digitized natural nail surface.

25. The method of claim 24 wherein the data representing the digitized natural nail surface is substituted for the data representing the artificial nail object in an area where the digitized natural nail surface intersects the artificial nail object.

26. A method for creating a digitized artificial nail object comprising:
a. receipt by a processor data representing a digitized natural nail surface; and
b. execution by the processor of computer readable instructions that merge data representing the digitized natural nail surface with a preselected artificial nail tip object to create an artificial nail object.

27. The method of claim 26 wherein the data is positioned on an X-axis, Y-axis and Z-axis.

28. The method of claim 27 wherein the method further includes measuring key reference points of a natural nail surface along the natural nail surface's X-axis, Y-axis, and Z-axis to obtain the data representing the digitized natural nail surface; where the X-axis represents the natural nail surface's width along a horizontal plane, the Y-axis represents the natural nail surface's length along a horizontal plane and the Z-axis represents the natural nail surface's height along a vertical plane.

29. The method of claim 28 wherein the step of measuring key reference points includes determining an arc of the natural nail surface along the X-axis and determining the arc of the natural nail surface along the Y-axis.

30. A method for creating a digitized artificial nail object comprising:
a. receipt by a processor of data representing a digitized natural nail surface; and
b. execution by the processor of computer readable instructions that include the following:
i. manipulating data representing the digitized natural nail surface; and
ii. generating additional data sufficient to generate a digitized artificial nail object that substantially conforms to a set of predetermined parameters.

31. The method of claim 30 wherein the data is positioned on an X-axis, Y-axis and Z-axis.

32. The method of claim 31 wherein the method further includes measuring key reference points of a natural nail surface along the natural nail surface's X-axis, Y-axis, and Z-axis to obtain the data representing the digitized natural nail surface; where the X-axis represents the natural nail surface's width along a horizontal plane, the Y-axis represents the natural nail surface's length along a horizontal plane and the Z-axis represents the natural nail surface's height along a vertical plane.

33. The method of claim 32 wherein the step of measuring key reference points includes determining an arc of the natural nail surface along the X-axis and determining the arc of the natural nail surface along the Y-axis.

34. A method for creating an digitized artificial nail object comprising:
a. receipt by a processor of data representing a spline; and
b. execution by the processor of computer readable instructions that include the following:
i. comparing data representing the spline with a library of spline objects; and
ii. selecting a spline object that substantially matches the data representing the spline.

35. The method of claim 34 wherein the selected spline object is morphed into a size and shape that substantially conforms to the data representing the spline.

36. A system for creating an artificial fingernail comprising:
means for converting an image of a natural nail into a digitized nail surface object;
means for manipulating the digitized nail surface object into an digitized artificial nail object; and
means for machining the digitized artificial nail object into an artificial fingernail.

37. The system of claim 36 further comprising a means for creating a digitized natural nail image.

38. A system for creating a custom fit, three-dimensional artificial fingernail wherein a portion of the artificial fingernail at least semi-rigidly retains a shape that substantially matches a top surface of a natural fingernail, the system comprising:
a. a non-contact measuring system operably measuring a three-dimensional topography of a natural fingernail, the measuring system comprising a light source and a camera;
b. a design system for designing the three-dimensional shape of the artificial fingernail by offering the selection of parameters comprising length, and three-dimensional style, of the artificial fingernail;
c. a calculation module within the design system for calculating a three-dimensional design of the artificial fingernail from the three-dimensional topography of the natural fingernail and the selected parameters; and
d. a machining device operably creating the artificial fingernail using the three-dimensional design of the artificial fingernail, the artificial fingernail at least semi-rigidly retaining a shape that substantially matches the top surface of the natural fingernail.

39. The system of claim 38 wherein the light source projects a pattern on the natural fingernail, the camera records a two-dimensional grid image of the natural fingernail and the design system calculates x, y, and z coordinates of the natural fingernail topography.

40. The system of claim 38 wherein the light source is a laser, and the non-contact measuring system scans the natural fingernail and calculates the three-dimensional topography of the natural fingernail.

41. The system of claim 38 wherein the non-contact measuring system converts the three-dimensional topography of the natural fingernail into a machine code for the machining device.

42. A computer implemented process for designing custom artificial fingernails for fitting a natural fingernail based on an optical image of the natural fingernail, the process comprising the steps of:
a. receiving from an optical imaging device image data defining a surface of a finger comprising a surface of a natural fingernail;
b. extracting from the image data a portion of image data that defines x, y, and z data points of the surface of the natural fingernail;
c. selecting a design for the artificial fingernail;
d. creating a three-dimensional data structure for the artificial fingernail wherein the data structure comprises the x, y, and z data points that defines the surface of the natural fingernail and the design for the artificial fingernail; and
e. converting the three-dimensional data structure into machine data for cutting the artificial fingernail out of a material.

43. The process of claim 42 wherein the step of selecting a design for the artificial fingernail further comprises the steps of:
a. selecting a length of the artificial fingernail;
b. selecting a thickness of the artificial fingernail;
c. and selecting a style of the artificial fingernail.

44. The process of claim 43 wherein the step of creating a three-dimensional data structure further comprises the steps of:
a. defining a top surface of the artificial fingernail wherein a portion of the top surface corresponds to the boundary of the surface of the natural fingernail;
b. defining a length of the artificial fingernail;
c. defining a thickness of the artificial fingernail; and
d. defining a style of the artificial fingernail.
